(19) United States
(12) Patent Application Publication
(10) Pub. No.: US 2008/0100589 A1
(43) Pub. Date: May 1, 2008

(54) Bezel assembly for assembling touch panel with LCD device

(76) Inventor: Heng-Lan Tsao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,638

(22) Filed: Oct. 16, 2007

(30) Foreign Application Priority Data
Oct. 27, 2006 (TW) 95219055

(51) Int. Cl. G06F 3/041

(52) U.S. Cl. 345/173

(57) ABSTRACT

A bezel assembly for assembling a touch panel with a LCD device includes an open-bottom integrating case having a front panel defining a central opening, a pair of first side supports downward extended from two opposite ends of the front panel, and a pair of second side supports downward extended from another two opposite ends of the front panel; a fixing frame for upward holding a touch panel to an underside of the front panel; and an open-top modular seat for supporting an LCD thereon. The modular seat with the LCD is upward assembled to the integrating case via the open bottom thereof to locate below the front panel, the touch panel, and the fixing frame by extending fastening elements through the first and second side supports of the integrating case into the modular seat.

### FIELD OF THE INVENTION

The present invention relates to a frame assembly, and more particularly to a bezel assembly for assembling a touch panel with an LCD device.

### BACKGROUND OF THE INVENTION

In recent years, touch panels have been widely applied in various types of electronic products, such as global positioning system (GPS), personal digital assistant (PDA), cellular phone, and hand-held personal computer (PC), to replace the conventional input devices. The use of touch panel enables electronic products to have a human-machine interface, enhancing an affinity between users and the electronic products. According to the operating principles, the touch panels may be divided into several types, such as optical, supersonic, infrared, capacitive, and resistive touch panels.

On the other hand, due to the highly development in liquid crystal display (LCD) techniques and various advantages provided by the LCD, the currently used displays have been gradually replaced by LCDs. Moreover, the LCD and touch panel techniques have been combined for use in many currently commercially available electronic apparatus, particularly the portable electronic apparatus, to provide users with more conveniences.

In prior art, a plurality of assembling frames are used to overlap and engage a touch panel with an LCD. These bezel assemblies require complicated and troublesome procedures to assemble the touch panels with LCD devices, and the touch panels and LCD devices could not be conveniently positioned into the bezel assemblies.

It is known that the touch panel and the LCD are normally designed and produced by different designers and manufacturers, and are independently sold. However, there is frequently a problem to match a touch panel with a LCD when it is desired to assemble a touch panel with an LCD device. Although some manufacturers are able to combine touch panel and LCD device into an integrated unit, the integration requires a complicated bezel assembly and causes difficulties in assembling and maintenance of the product. And, such combination of touch panel and LCD is limited to only some specific product models and could not be broadly applied to a wide range of touch panel and LCD products.

### SUMMARY OF THE INVENTION

A primary object of the present invention is to provide a bezel assembly for assembling a touch panel with an LCD device that enables easy assembly of a touch panel and an LCD device to form an integrated unit.

Another object of the present invention is to provide a bezel assembly for assembling a touch panel with an LCD device that provides broad applicability and can therefore be conveniently used with LCD-supporting modular seats of different designs.

To achieve the above and other objects, a bezel assembly for assembling a touch panel and an LCD device is provided. The bezel assembly includes an open-bottom integrating case having a front panel defining a central opening, a pair of first side supports downward extended from two opposite ends of the front panel, and a pair of second side supports downward extended from another two opposite ends of the front panel; a fixing frame for upward holding a touch panel to an underside of the front panel; and an open-top modular seat for supporting an LCD thereon. The modular seat with the LCD is upward assembled to the integrating case via the open bottom thereof to locate below the front panel, the touch panel, and the fixing frame by extending fastening elements through the first and second side supports of the integrating case into the modular seat.

In a preferred embodiment of the present invention, the integrating case further includes a horizontal flange portion formed around and outward extended from the front panel, and the flange portion is provided at an underside with a plurality of externally threaded rods, so that the whole bezel assembly may be mounted in an opening formed on a control panel of an apparatus by downward extending the threaded rods of the integrating case through mounting holes correspondingly formed on the control panel and screwing nuts to the threaded rods downward projected from the mounting holes.

Unlike the conventional techniques for assembling touch panel and LCD that involve in complicate assembling procedures and could not be conveniently applied to different types of touch panels and LCDs, the bezel assembly of the present invention includes an integrating case, a fixing frame, and a modular seat that could be easily manufactured and assembled to conveniently assemble a touch panel and an LCD into one unit. Moreover, the integrating case of the present invention can be conveniently applied to LCD-supporting modular seats of different designs, making the present invention commercially valuable and practical for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled perspective view of a bezel assembly for assembling a touch panel with an LCD device according to a first embodiment of the present invention;

FIG. 2 is an exploded perspective view of the bezel assembly of FIG. 1;

FIG. 3 is a cross-sectional view taken along line 3-3 of FIG. 1;

FIG. 4 is an exploded perspective view of a bezel assembly for assembling a touch panel with an LCD device according to a second embodiment of the present invention; and

FIG. 5 is an assembled cross-sectional view of the bezel assembly according to the second embodiment of the present invention.

### DETAILED DESCRIPTION OF THE PREFERRED EMBODIMENTS

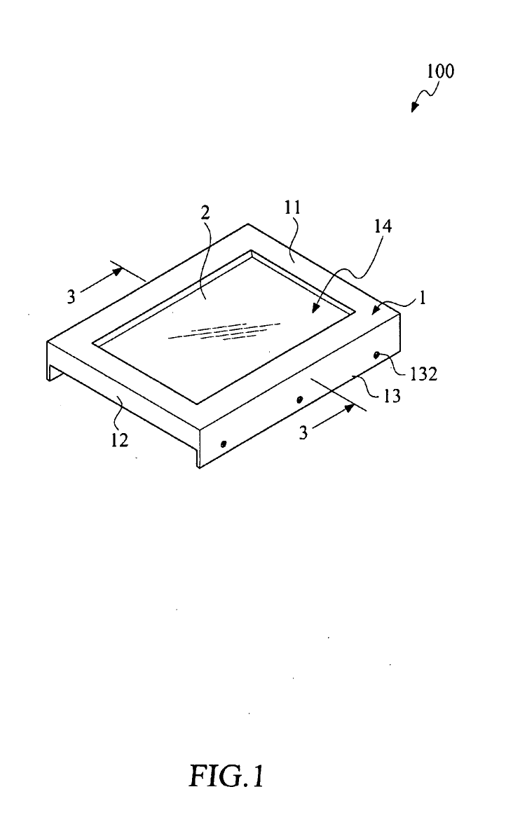

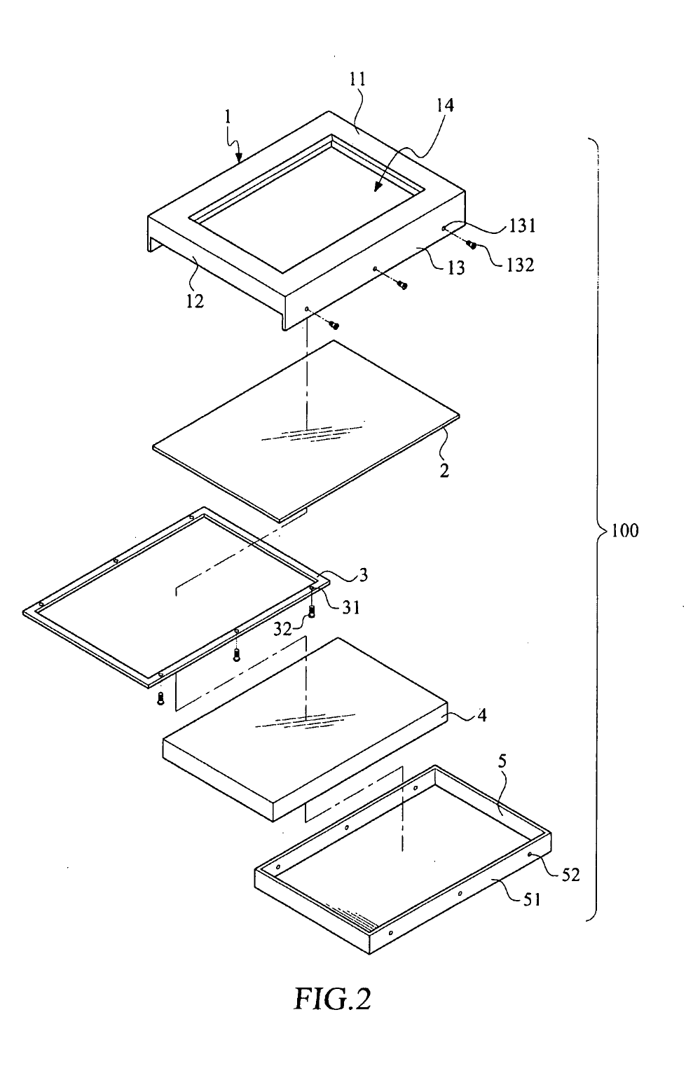

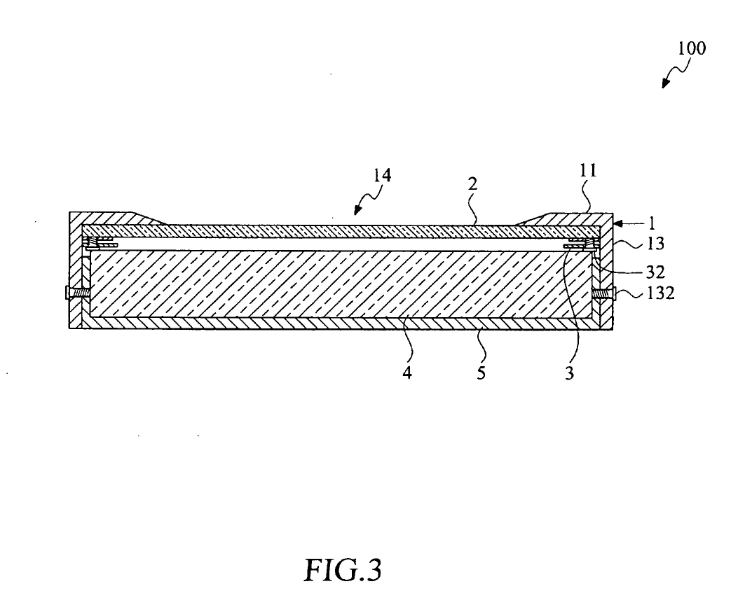

Please refer to FIGS. 1 and 2 that are assembled and exploded perspective views, respectively, of a bezel assembly for assembling a touch panel with an LCD device 100 according to a first embodiment of the present invention, and to FIG. 3 that is a cross-sectional view taken along line 3-3 of FIG. 1.

As shown, the bezel assembly for assembling a touch panel with an LCD device 100 includes an open-bottom integrating case 1, a fixing frame 3, and a modular seat 5.

The integrating case 1 consists of a front panel 11, a pair of first side supports 12, and a pair of second side supports 13. The front panel 11 defines a central opening 14, via which a user may operate a touch panel mounted below the front panel 11, and an LCD display located below the touch panel may show a screen. The first side supports 12 are downward extended from two opposite sides of the front panel 11 by a predetermined first distance, and the second side supports 13 are downward extended from another two opposite sides of the front panel 11 by a predetermined second distance, which is larger than the first distance. At least one screw hole 131 is formed on each of the second side supports 13.

A touch panel 2 may be securely mounted to and below the front panel 11 from the open bottom of the integrating case 1 using the fixing frame 3. For this purpose, the fixing frame 3 is formed at predetermined positions with a plurality of screw holes 31, via which fastening elements 32 may upward screwed to tightly hold the touch panel 2 to and below the front panel 11, such that a central display area of the touch panel 2 is aligned with and located right below the central opening 14 of the front panel 11, and the integrating case 1, the touch panel 2, and the fixing frame 3 together form an assembly.

The modular seat 5 is an open-top supporting structure having four upward extended vertical sidewalls 51 of a predetermined height for supporting an LCD 4 thereon. The vertical sidewalls 51 are formed at predetermined positions with a plurality of screw holes 52.

When the LCD 4 has been seated in the modular seat 5, an assembly of the LCD 4 and the modular seat 5 is upward assembled to a lower side of the assembly of the integrating case 1, the touch panel 2, and the fixing frame 3. At this point, fastening elements 132 may be fastened through the screw holes 131 formed on the second side supports 13 of the integrating case 1 into the screw holes 52 formed on the vertical sidewalls 51 of the modular seat 5 to securely locate the LCD 4 between the first and the second side supports 12, 13 of the integrating case 1 and below the touch panel 2.

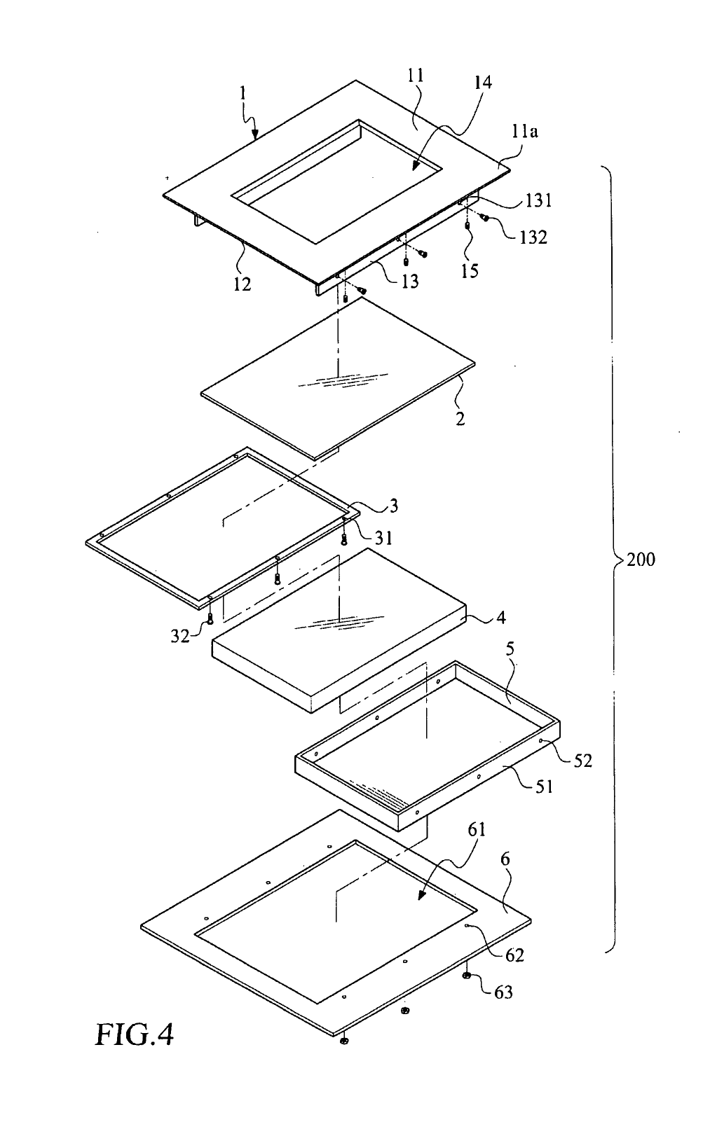

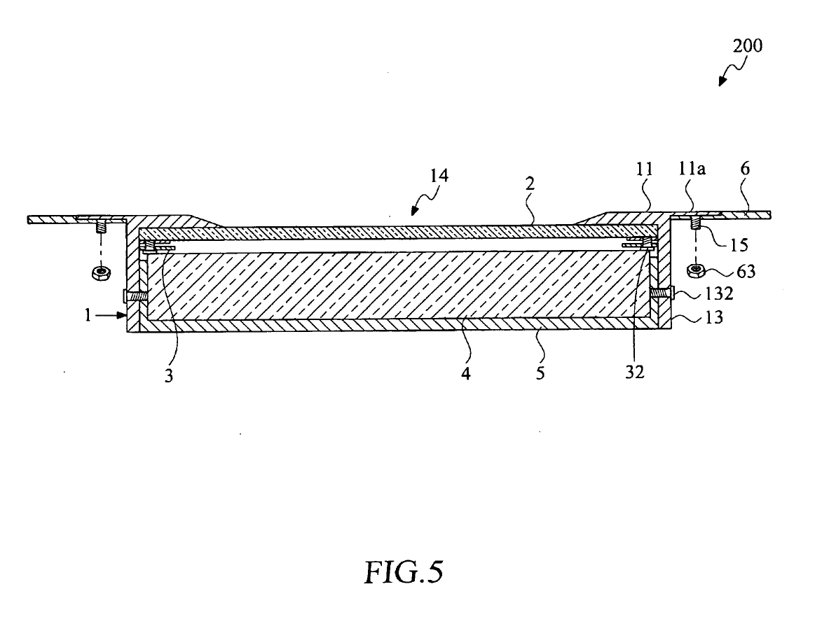

FIGS. 4 and 5 are exploded perspective view and assembled sectional view, respectively, of a bezel assembly for assembling a touch panel with an LCD device 200 according to a second embodiment of the present invention. Since the bezel assembly 200 in the second embodiment is generally structurally similar to the bezel assembly 100 in the first embodiment, components that are the same or similar in the two embodiments are denoted the same reference numerals. The bezel assembly 200 is different from the bezel assembly 100 in that the assembling case 1 of the bezel assembly 200 further includes a flange portion 11a located around and horizontally outward extended from the front panel 11, and a plurality of externally threaded rods 15 are downward extended from an underside of the horizontal flange portion 11a.

The bezel assembly 200 could be conveniently mounted to a predetermined opening 61 on a control panel 6 of an apparatus. To mount the bezel assembly 200 to the control panel 6, it is simply needed to drill mounting holes 62 on the control panel 6 corresponding to the threaded rods 15 below the horizontal flange portion 11a, then the bezel assembly 200 may be set in the opening 61 on the control panel 6 with the threaded rods 15 downward extended through the mounting holes 62. At this point, by screwing a plurality of nuts 63 to the threaded rods 15 downward projected from the mounting holes 62, the bezel assembly 200 is securely assembled to the control panel 6.

The bezel assembly of the present invention may be manufactured using general machining techniques, including stamp-forming, fastening with screws, sheet pressing and bending, etc., to effectively reduce the manufacturing cost thereof. Moreover, the bezel assembly of the present invention allows convenient assembling of the touch panel 2 and the LCD 4 thereto. These factors make the bezel assembly of the present invention highly commercially valuable and practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A bezel assembly for assembling a touch panel with an LCD device, comprising:
an open-bottom integrating case having a front panel defining a central opening, and at least one pair of side supports downward extended from the front panel by a predetermined distance, such that the touch panel may be set in the integrating case via the open bottom thereof;
a fixing frame for upward holding the touch panel set in the integrating case to an underside of the front panel; and
an open-top modular seat for supporting an LCD thereon and setting between the at least one pair of downward extended side supports of the integrating case;
whereby when the LCD has been seated in the modular seat, the modular seat with the LCD may be upward assembled to the integrating case via the open bottom thereof to locate below the front panel, the touch panel, and the fixing frame by extending fastening elements through the pair of side supports of the integrating case into the modular seat.

2. The bezel assembly as claimed in claim 1, wherein the at least one pair of side supports includes:
a pair of first side supports downward extended from two opposite ends of the front panel by a first distance; and
a pair of second side supports downward extended from another two opposite ends of the front panel by a second distance, which is larger than the first distance.

3. The bezel assembly as claimed in claim 1, wherein the fixing frame is provided at predetermined positions with a plurality of screw holes, via which fastening elements may be upward screwed to tightly hold the touch panel to and below the front panel, such that a central display area of the touch panel is aligned with and located right below the central opening of the front panel.

4. The bezel assembly as claimed in claim 1, wherein the modular seat has four upward extended vertical sidewalls of a predetermined height, and the four upward extended vertical sidewalls being formed at predetermined positions with a plurality of screw holes.

5. A bezel assembly for assembling a touch panel with an LCD device, comprising:
an open-bottom integrating case having a front panel defining a central opening, at least one pair of side supports downward extended from the front panel by a predetermined distance, such that the touch panel may be set in the integrating case via the open bottom thereof, and a flange portion located around and horizontally outward extended from the front panel;
a fixing frame for upward holding the touch panel set in the integrating case to an underside of the front panel; and
an open-top modular seat for supporting an LCD thereon and setting between the at least one pair of side supports of the integrating case;
whereby when the LCD has been positioned in the modular seat, the modular seat with the LCD may be upward assembled to the integrating case via the open bottom thereof to locate below the front panel, the touch panel, and the fixing frame by extending fastening elements through the pair of side supports of the integrating case into the modular seat.

6. The bezel assembly as claimed in claim 5, wherein the horizontal flange portion of the integrating case is formed on an underside with a plurality of downward extended and externally threaded rods, such that the whole bezel assembly may be mounted in an opening on a control panel of an apparatus simply by drilling mounting holes on the control panel corresponding to the threaded rods below the horizontal flange portion of the integrating case, setting the whole bezel assembly in the opening of the control panel with the threaded rods downward extended through the mounting holes, and screwing a nut to each of the threaded rods downward projected from the mounting holes.
